(19) United States
(12) Patent Application Publication
(10) Pub. No.: US 2003/0042107 A1
(43) Pub. Date: Mar. 6, 2003

(54) Drive reaction plate for centrifugal clutch module

(75) Inventor: Daniel V. Gochenour, Auburn, IN (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation

(21) Appl. No.: 09/943,490

(22) Filed: Aug. 30, 2001

(51) Int. Cl. F16D 43/04

(52) U.S. Cl. 192/105 C

(57) ABSTRACT

A drive reaction plate for insertion between a ramp plate and a centrifugal actuation module of a centrifugally actuated vehicular clutch. The annular body of the reaction plate is secured to the ramp plate, while an interior diameter of the reaction plate includes drive straps for resilient attachment to the centrifugal module. The straps are adapted to flex upon clutch engagement, to unflex upon clutch release, and to dampen torsional vibrations between the clutch ramp plate and the centrifugal actuation module. The reaction plate includes openings for ramp segments of the ramp plate, and the ramp segments extend into the plate openings to maintain angular locations of the segments relative to cooperating rollers of the centrifugal module. The reaction plate is formed of thin spring metal, and is bolted or riveted directly to the ramp plate to avoid misalignment of the reaction plate during the useful life of the clutch.

### BACKGROUND OF THE INVENTION

1. Field of Invention

This invention relates generally to an improved device for locating a weight and roller centrifugal module within a housing of an automatic centrifugal clutch, as well as for dampening torsional vibrations between the centrifugal module and an associated clutch actuation ramp plate. More particularly, the invention relates to improvements in function of centrifugal weight and wear compensation modules affixed to clutch covers, and commensurately to reduced rates of wear of friction linings in vehicular clutches.

2. Description of the Prior Art

Those skilled in the art of automatically actuated centrifugal clutches will appreciate that clutch actuation modules of the type including centrifugal weights affixed to vehicular clutch covers, and radially movable with respect thereto as a function of engine speed against spring loads, have several issues that work against satisfactory operation of the modules over the useful lives of the clutches. For example, one such centrifugal module, bolted or otherwise rigidly attached to an engine flywheel ring, has been associated with short friction lining life. It has been recognized that the module should be free to move axially inwardly toward the pressure plate during the normal wear cycle of the clutch. Because this has not been permitted to occur, additional stresses have been placed on the surfaces of the wear compensation module cam segments, occasionally overstressing the structures and rendering them inoperable.

In addition, when the centrifugal module is rigidly attached to the flywheel ring, not only is there no permissible axial movement; there is also no angular movement of the module with respect to the flywheel ring. The result can be that any torsional vibrations from the engine will be transmitted directly into the centrifugal module without dampening. This works against proper functioning of the associated clutch wear compensation mechanism, results in undesirable clutch travel, and actually defeats the purpose of having a clutch wear compensation mechanism.

Finally, locating the centrifugal module within the clutch cover during manufacture has traditionally involved the clutch wear compensation cam segments as a principal means of centering the module. This method of location produces undesirable tolerance stack ups with respect to concentricity of the centrifugal module, limits proper functioning of the mass weight rollers and the ramp plate reaction segments, and detracts from overall efficiency and performance of the module.

### SUMMARY OF THE INVENTION

The present invention provides improved operation of a centrifugal actuation module in a centrifugally actuated vehicular clutch. A clutch drive reaction plate is attached to a ramp plate positioned adjacent the centrifugal actuation module. The reaction plate includes a plurality of circumferentially positioned drive straps adapted to flex upon clutch engagement, and unflex upon clutch release. The straps are arranged in regularly spaced angular intervals about the internal diameter of the annular reaction plate, and are attached directly to a plurality of lugs axially extending from the module, wherein the lugs are also spaced apart at regular angular intervals.

The reaction plate is particularly designed to dampen torsional vibrations between the clutch ramp plate and the centrifugal actuation module. The reaction plate includes openings for receiving ramp segments extending axially from and forming a part of the ramp plate. The accommodation of the ramp segments within the openings facilitates locating the segments relative to interactive rollers attached to centrifugally operated spring weights in the centrifugal module. The ramp segments and rollers can otherwise become angularly misaligned due to torsional vibrations that occur during engine operation.

In the described embodiment, the reaction plate is formed of thin spring metal, preferably of high carbon steel, such as SAE 1080 spring steel. The reaction plate may be bolted or riveted directly to the ramp plate, and is attached to the module through circumferentially disposed straps. This connection feature avoids likelihood of misalignment of the ramp plate relative to the module during the useful life of the clutch, while assuring axial flexibility of the module relative to the ramp plate. Such flexibility has been determined to be necessary for optimizing clutch friction lining life.

### BRIEF DESCRIPTION OF THE DRAWINGS

FIG. 1 is a cross-sectional view of a normally open centrifugal clutch that includes the clutch drive reaction plate of the present invention.

FIG. 2 is an enlarged cut away view of a portion of the centrifugal clutch of FIG. 1, revealing interaction of a weight roller system of a centrifugal weight-spring clutch actuation module of the clutch with a ramp segment of a clutch actuation ramp plate, and also showing the drive reaction plate positioned against the ramp plate.

FIG. 3 is an enlarged perspective view of the centrifugal module.

FIG. 4 is an exploded view of components downstream of the centrifugal module, including the drive reaction plate, the ramp plate, a clutch diaphragm spring, and a pressure plate as arranged in the centrifugal clutch of FIG. 1.

FIG. 5 is a face view of the embodiment of the clutch drive reaction plate shown in FIGS. 2 and 4.

FIG. 6 is an alternate embodiment of the drive reaction plate.

### DETAILED DESCRIPTION OF THE EMBODIMENTS

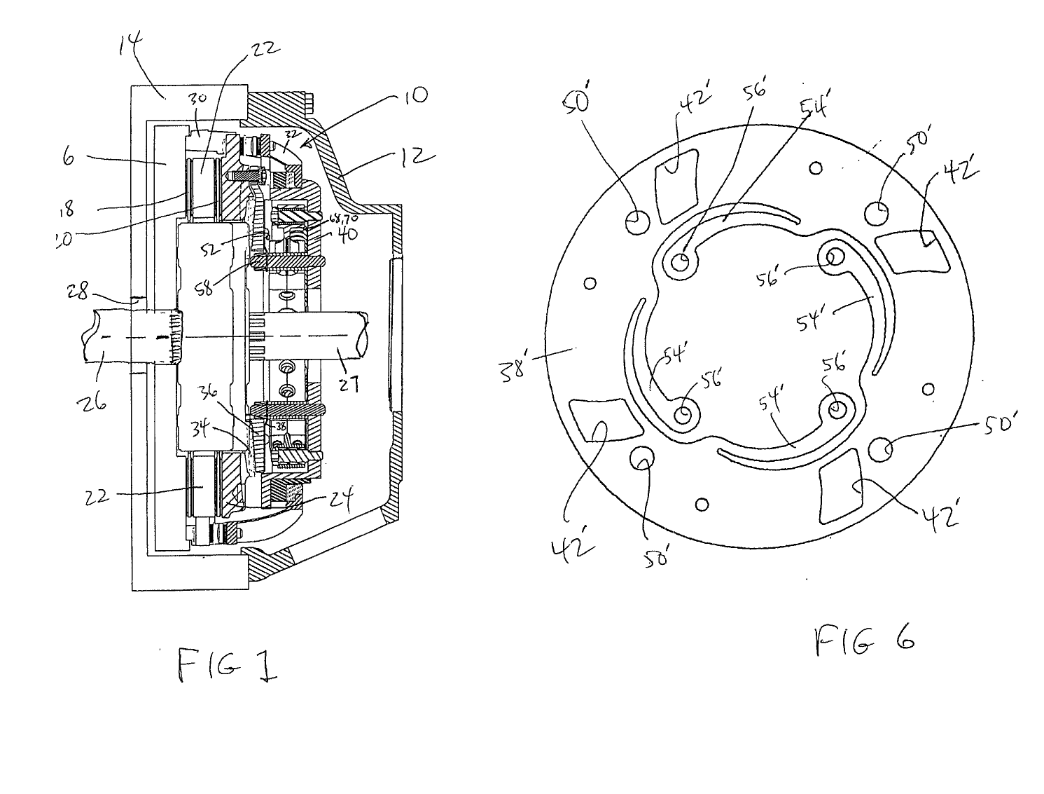

Referring initially to FIG. 1, an automatically actuated centrifugal clutch 10 is designed for use in a motor vehicle, not shown. The clutch 10 is enshrouded between a bell housing 12 of a transmission (also not shown) and a flywheel shroud or housing 14 coupled externally to the bell housing 12. The centrifugal clutch 10 is of the normally unengaged type that relies upon engine speed to initiate actuation, and hence engagement. The clutch may be used with an electromechanical style automatic transmission, and is employed in vehicles that are normally without a clutch pedal.

The flywheel housing 14 envelops an engine flywheel 16 that is bolted to an engine crankshaft 26 for direct rotation therewith. In the embodiment described, a pair of friction plates 18, 20 includes friction linings 21, 23, secured to the plates 18, 20 via traditional fasteners, which may be rivets, bolts, or adhesives, etc. The friction plates are adapted to be releasably clasped between the flywheel 16, an intermediate plate 22, and a pressure plate 24. The friction plates 18, 20 are directly attached to, and rotate with, a transmission input shaft 27. Those skilled in the art will appreciate that the transmission input shaft 27 is positioned coaxially with respect to the engine crankshaft 26, but is axially spaced therefrom as depicted.

The engine crankshaft 26 is affixed to the engine flywheel 16. For this purpose, the shaft 26 extends through an aperture 28 of the flywheel housing 14 as shown. A circumferentially extending flywheel ring 30 is rigidly affixed to the flywheel 16, and an external clutch cover 32 is secured to the flywheel ring. In some cases, the ring 30 and cover 32 may be the same part, and this invention is intended to cover such cases. The clutch cover, the pressure plate 24, and the intermediate plate 22 are all affixed to the flywheel ring 30 in a manner such that all of the respectively described members are permitted to move axially, though non-rotatably, in reference to the flywheel ring. Thus, as the flywheel ring 30 rotates during operation of the vehicle engine, the described coupled members all rotate together at the same speed as the ring 30.

Indeed all members as will be described herein rotate with the flywheel ring 30 with the exception of the pair of friction plates 18, 20 that are clasped, i.e. “clutched”, between the axially movable flywheel 16, the intermediate plate 22, and the pressure plate 24 as described above. In addition, it will be appreciated that all of the plates, apart from the plates 18, 20 are annular in shape, as required to permit the transmission input shaft 27 to pass through the centers of each of the plates that rotate with the flywheel ring 30.

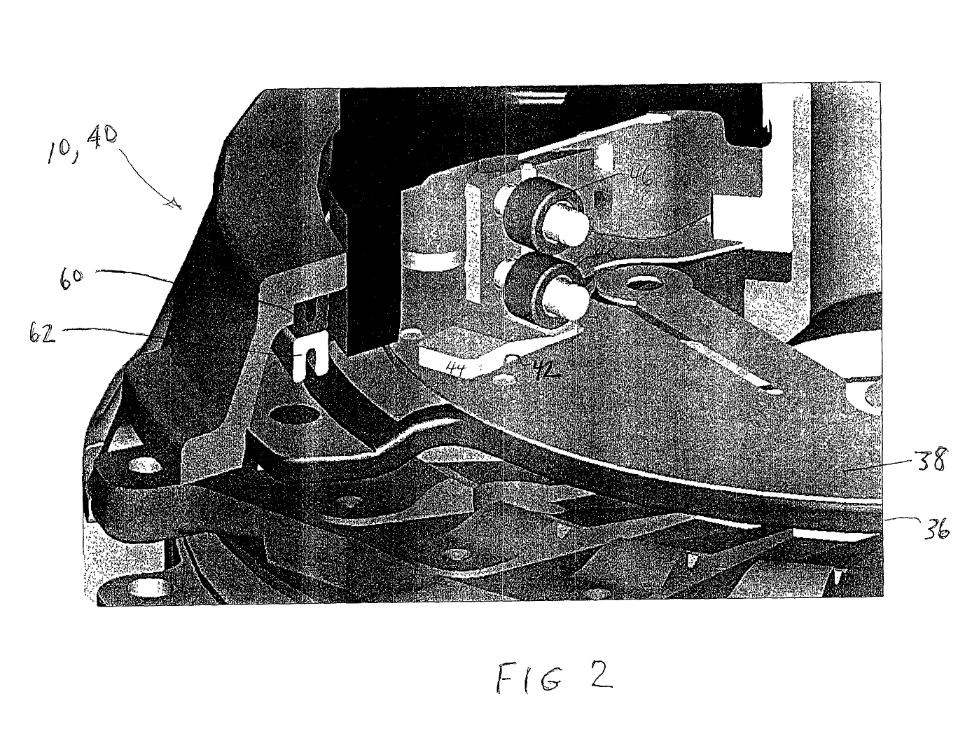

Continuing reference to FIG. 1, any leftward movement of the pressure plate 24 actuates the clutching of the friction plates 18, 20. Referring now also to FIGS. 2 and 3, in order to initiate such clutching, a centrifugal module 40 is provided, the module having a circumferentially arranged plurality of weights 64 that are pivotally disposed within the housing 72 of the centrifugal module 40. The weights are attached to pivot links 66 fixed to the housing 72, and are adapted to swing radially outwardly against centrifugal force induced upon them by engine speed. The amount of angular pivotal movement of the weights 64 is controlled by compression springs 68, 70 that are secured between the weights 64 and the internal diameter 74 of the module housing 72.

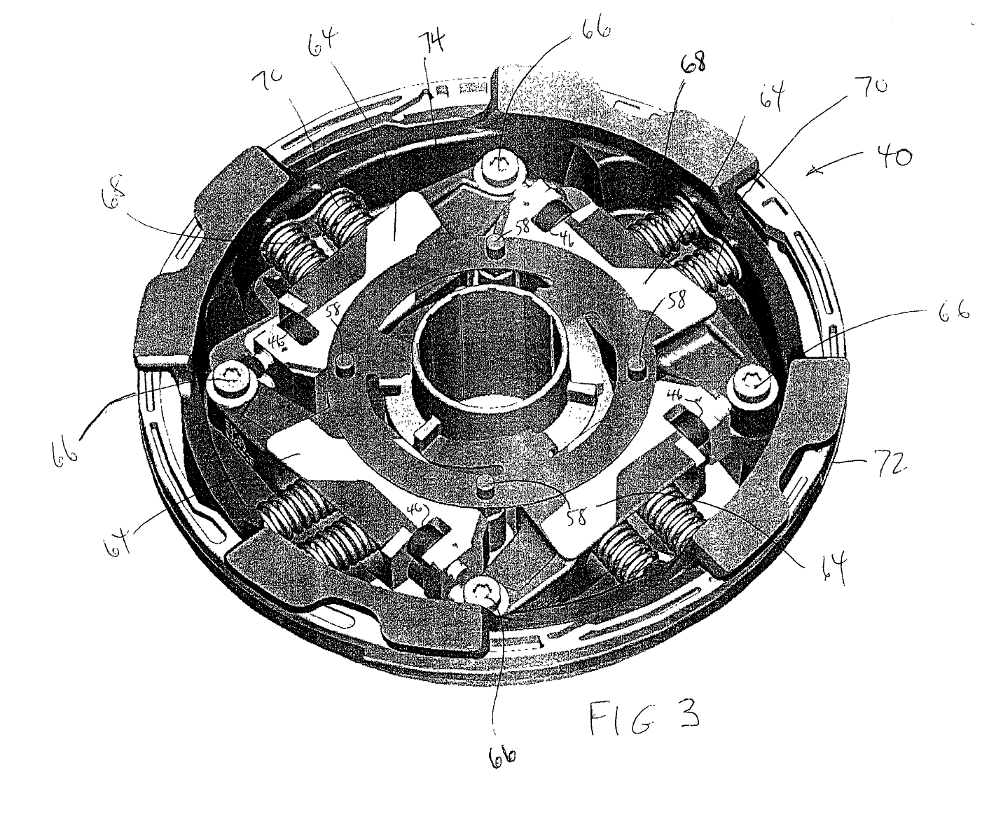

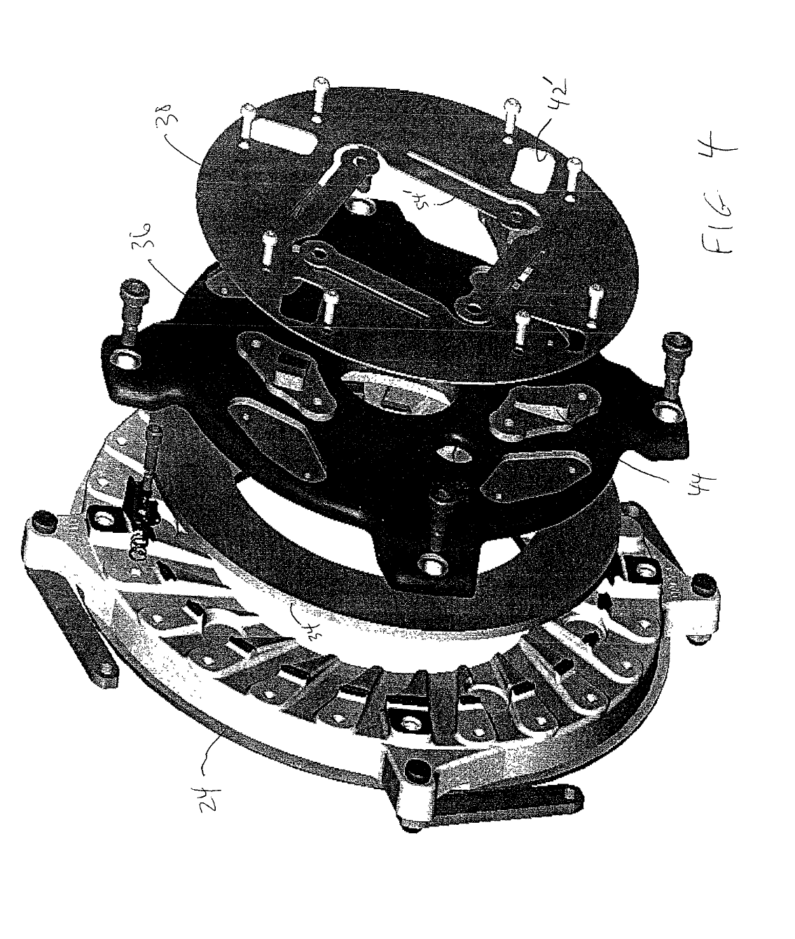

Continuing reference to FIGS. 2 and 3, it will be appreciated that the rollers 46, 48 move radially outwardly under centrifugal force since they are attached to the weights 64. The axially fixed rollers, however, interact with axially movable ramp segments 44 (FIGS. 2 and 4) of a ramp plate 36 (FIGS. 1, 2, and 4) to cause the ramp plate 36 to move leftwardly (FIG. 4) against the force of a resilient diaphragm spring 34 (FIGS. 1 and 4). This action produces the clutching action earlier described, wherein the friction plates 18, 20 become coupled, i.e. rotationally locked, to the flywheel 16, as will be appreciated by those skilled in the art.

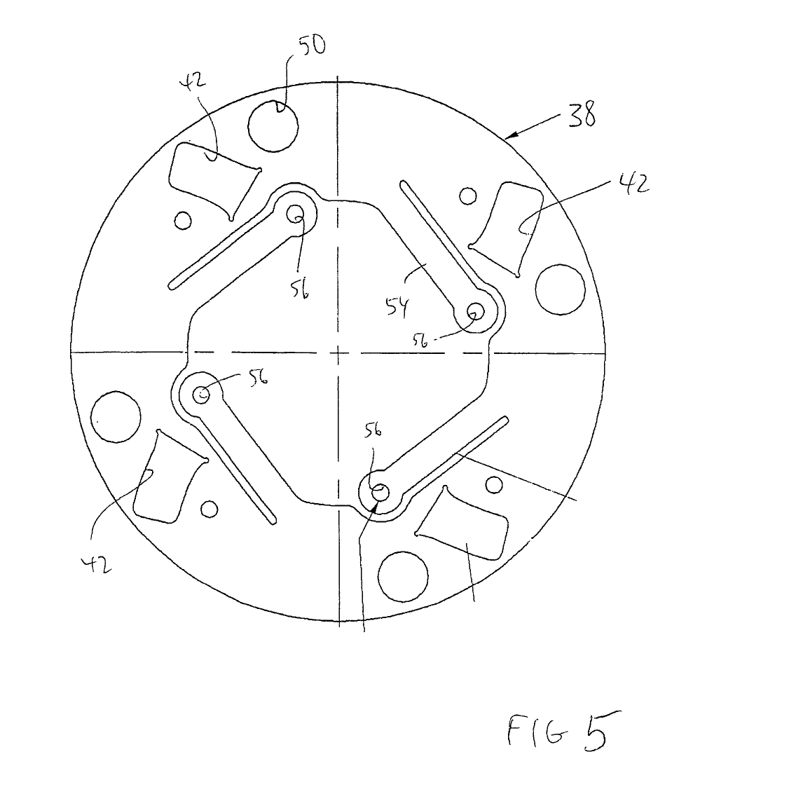

The ramp plate 36 directly engages the diaphragm spring 34 as depicted in FIGS. 1 and 4. In accordance with this invention, and referring now particularly to FIGS. 1, 2, 4, and 5, an annular drive reaction plate 38 of a thin spring metal is interposed between the ramp plate 36 and the centrifugal clutch actuation module 40. In the described embodiment, the plate 38 is formed of high carbon spring steel, such as SAE 1080 spring steel. The drive reaction plate includes apertures 42 for receiving and capturing a plurality of rectangular ramp segments 44 that are circumferentially angularly distributed about the ramp plate 36, each segment being rigidly secured to the ramp plate 36. In the described embodiment, the apertures 42 are also generally rectangular in shape, so as to closely circumscribe the ramp segments 44, as desirable for greatest effectiveness.

Sets of circumferentially spaced pairs of spring-loaded rollers 46, 48 are adapted to directly engage respective ramp segments 44 as shown in FIG. 2. The drive reaction plate 38 includes apertures 50 for attaching the plate 38 directly to the ramp plate 36 via fasteners 52 (FIG. 1), which may be bolts or rivets for example. The plate 38 also includes a plurality of spaced resilient straps 54 having apertures 56 to permit the attachment of the straps 54 to connection lugs 58 (FIG. 3) of the module 40.

The spring metal straps 54 of the plate 38 are secured to the lugs 58 to provide a resilient axial relative movement capability between the ramp plate 36 and the module 40; no relative rotational movement is enabled by the connection. Those skilled in the art will appreciate that such a connection facilitates the operation of the pair of wear ramps 60, 62 (FIG. 2) employed to compensate for wear of the friction linings of the friction plates 18, 20.

As the speed of the engine increases, e.g. as measured in revolutions per minute of the crankshaft 26, the weights 64 will be urged radially outwardly against the compressive forces of the springs 68, 70. Centrifugal forces on the weights will cause the weights to pivot radially outwardly a distance proportional to the engine speed. In the described embodiment, the clutch 10 will remain disengaged at idle speeds in the range of 750 rpm, as the forces of the springs 68, 70 will be sufficient to counter the centrifugal forces on the weights 64 at that engine speed. Upon additional engine fueling rates, the engine speed will progress to higher values resulting in clutch actuation movement initiated by the rollers 46, 48 against the ramps 44. By the time the clutch assembly 10 is rotating at speeds in the range of 900 to 1200 rpm, the clutch 10 will be fully engaged, and the friction disks 18, 20 fully clutched.

FIG. 6 is an alternate embodiment 38′ of the drive reaction plate of this invention. All corresponding elements (as indicated by identical reference numerals with primes) are identical to the drive reaction plate 38, except for the straps 54′, which are shaped so as to incorporate circumferential arcs that defines the internal diameter of the plate 38′.

Finally, depending on desired load characteristics involved in the actuation movements between the centrifugal module 40 and the reaction plate 36, the drive straps 54, 54′ may be preloaded in the released condition for providing a lower load between the pressure plate 24 and the centrifugal module 40, which will then increase as the clutch is engaged. Of course the lower load achieved in the clutch-engaged position should not produce a value below the desired clutch-engaged pressure plate load. In any event, the strap shape can thus be varied to achieve various spring rates and load characteristics, strictly as a function of clutch actuation dynamics.

It is to be understood that the above description is intended to be illustrative and not limiting. Many embodiments will be apparent to those skilled in the art upon reading the above description. The scope of the invention should be determined, however, not with reference to the above description, but with reference to the appended claims with full scope of equivalents to which such claims are entitled.

What is claimed is:

1. A clutch drive reaction plate adapted for use in a centrifugally actuated vehicular clutch, said reaction plate comprising an annular spring metal body adapted for securement to a ramp plate of a centrifugal actuation module, wherein said module includes actuating weights with attached rollers adapted to engage ramps fixed to said ramp plate, said ramp plate adapted to rotate with said module but axially displaceable with respect thereto; said reaction plate including at least one resilient drive strap coupled to said module, wherein said strap is adapted to flex upon clutch engagement, and unflex upon clutch release.

2. The clutch drive reaction plate of claim 1 wherein said reaction plate is adapted to dampen torsional vibrations between said clutch ramp plate and said centrifugal actuation module, wherein said ramp plate comprises ramp segments, and said reaction plate includes openings for the ramp segments so that the ramp segments extend into said openings to maintain relative angular locations of the ramp segments with respect to said module.

3. The clutch drive reaction plate of claim 4 wherein said reaction plate comprises an annular body, and wherein said drive strap generally circumscribes an arc of the internal diameter of said reaction plate.

4. The clutch drive reaction plate of claim 3 wherein the reaction plate is formed of thin spring metal that is secured directly against the ramp plate for avoiding misalignment of the reaction plate.

5. The clutch drive reaction plate of claim 4 wherein said reaction plate comprises a plurality of said drive straps.

6. The clutch drive reaction plate of claim 2 wherein said straps of said reaction plate are attached to lugs extending from said module.

7. The clutch drive reaction plate of claim 6 wherein said reaction plate is secured to said ramp plate by fasteners.

8. The clutch drive reaction plate of claim 7 wherein said openings of said drive reaction plate are circumferentially spaced about said annular body of said reaction plate.

9. The clutch drive reaction plate of claim 8 wherein said plate is formed of a spring steel of high carbon content.

10. The clutch drive reaction plate of claim 9 wherein said reaction drive plate straps define the internal diameter of said annular reaction plate.

11. The clutch drive reaction plate of claim 10 wherein said reaction plate has drive straps that extend in a direction coincident with an arc of the internal diameter of said annular plate.

12. The clutch drive reaction plate of claim 11 wherein said reaction plate is formed of SAE 1080 spring steel.

13. A clutch drive reaction plate adapted for use in a centrifugally actuated vehicular clutch, said reaction plate comprising an annular spring metal body adapted for securement to a ramp plate of a centrifugal actuation module, wherein said module includes actuating weights with attached rollers adapted to engage ramps fixed to said ramp plate, said ramp plate adapted to rotate with said module but axially displaceable with respect thereto; said reaction plate including at least one resilient drive strap coupled to said module, wherein said strap is adapted to flex upon clutch engagement, and unflex upon clutch release, wherein said ramp plate comprises ramp segments, and said reaction plate includes openings for the ramp segments so that the ramp segments extend into said openings to maintain relative angular locations of the ramp segments with respect to said module, and wherein said openings closely circumscribe the ramp segments.

14. A clutch drive reaction plate adapted for use in a centrifugally actuated vehicular clutch, said reaction plate comprising an annular spring metal body adapted for securement to a ramp plate of a centrifugal actuation module, wherein said module includes actuating weights with attached rollers adapted to engage ramps fixed to said ramp plate, said ramp plate adapted to rotate with said module but axially displaceable with respect thereto; said reaction plate including at least one resilient drive strap coupled to said module, wherein said strap is adapted to flex upon clutch engagement, and unflex upon clutch release, wherein said ramp plate comprises ramp segments, and said reaction plate includes openings for the ramp segments so that the ramp segments extend into said openings to maintain relative angular locations of the ramp segments with respect to said module, wherein said openings closely circumscribe the ramp segments, and wherein further said openings are generally rectangular.
